(19) United States
(12) Patent Application Publication
(10) Pub. No.: US 2024/0052151 A1
(43) Pub. Date: Feb. 15, 2024

(54) CBC LIGHT STRIP STRUCTURE CAPABLE OF GUIDING ULTRAVIOLET LIGHT

(71) Applicants: YING TSUNG FAN, Taipei City (TW); CHIEN CHENG CHEN, Taipei City (TW)

(72) Inventors: YING TSUNG FAN, Taipei City (TW); CHIEN CHENG CHEN, Taipei City (TW)

(21) Appl. No.: 17/818,363

(22) Filed: Aug. 9, 2022

(51) Int. Cl. F21V 8/00; G02B 1/04; F21V 7/00; F21V 13/04; G06K 7/10; C08L 53/00; C08L 25/10

(52) U.S. Cl. CPC G02B 6/0018; G02B 1/046; F21V 7/0033; F21V 13/04; G02B 6/0065; G06K 7/10722; C08L 53/00; C08L 25/10; F21V 2200/20

(57) ABSTRACT

A CBC light strip structure capable of guiding ultraviolet light includes a light strip; the light strip being formed by cyclic block copolymers (CBCs); the light strip having an input end to receive ultraviolet (UV) light; the ultraviolet light being guided by the light strip and passes through the light strip from the input end to an output end of the light strip.

### FIELD OF INVENTION

The present invention relates to a light strip, and in particular to a CBC (cyclic block copolymer) light strip structure capable of guiding ultraviolet light.

### BACKGROUND OF INVENTION

In prior arts, an image scanning device has a light strip for emitting linear light to illuminate and scan a document, and receives reflected light from the document to rebuild a scanned image.

In general, the light strip is made of acrylic. The light strip has an input end to receive external input infrared (IR) light. By full reflection, the infrared light passes through the light strip from the input end to an output end of the light strip. A side of the light strip forms at least one dielectric reflecting area. The dielectric reflecting area is a high dielectric permittivity area to reflect the infrared light in the light strip so as to change an angle between a direction of infrared light and a radial direction of the light strip. Therefore, the infrared light penetrates out of a side of the dielectric reflecting area of the light strip and illuminates an external portion of the light strip. In that, the dielectric reflecting area is formed by coating ink or carving scratches on the side of the light strip.

However, the above light strip made of acrylic only absorbs infrared light and thus only forms an infrared light source. The infrared light source has many limitations in photosensitive applications. The infrared light cannot be used to scan documents (banknotes, identity cards or passports) which have special design and only can be scanned by ultraviolet (UV) light.

For forming an ultraviolet light source, other kinds of light-emitting components are required. For example, a plurality of LEDs are installed on a light strip to form a LED light strip and the LEDs are powered by external inputting current to emit ultraviolet light. However, this light strip with LEDs has high costs and complex producing process. Moreover, the LED light strip must be scrapped once one of the LEDs is damaged.

Therefore, all these defects in the prior art are necessary to be improved.

### SUMMARY OF THE INVENTION

To improve above defects in the prior art, the present invention provides a CBC (cyclic block copolymer) light strip structure capable of guiding ultraviolet light. Advantages of the present invention are that the CBC light strip structure is made of cyclic block copolymers (CBCs) for guiding the ultraviolet light. Therefore, the light strip of the present invention can be used to scan documents which only can reflect ultraviolet light, such as banknotes, identity cards, passports and so on. The structure of the present invention can overcome the problem that the acrylic light strip cannot guide ultraviolet light. Comparing to traditional LED light strip, the light strip of the present invention has a simple structure and low costs. The light strip of the present invention does not have the problem that the LED light strip must be scrapped once the LED is damaged, thus the light strip of the present invention has longer service life.

To achieve above object, the present invention provides a CBC light strip structure capable of guiding ultraviolet light comprising a light strip formed by cyclic block copolymers (CBCs); the light strip having an input end to receive ultraviolet (UV) light; the ultraviolet light being guided by the light strip and passing through the light strip from the input end to an output end of the light strip.

### BRIEF DESCRIPTION OF THE DRAWINGS

FIG. 1 is an assembly schematic view of the present invention.

FIG. 2 is another assembly schematic view of the present invention.

FIG. 3 is a schematic view showing that the ultraviolet light is guided within the light strip and penetrates out of the light strip to form a linear illuminating area.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

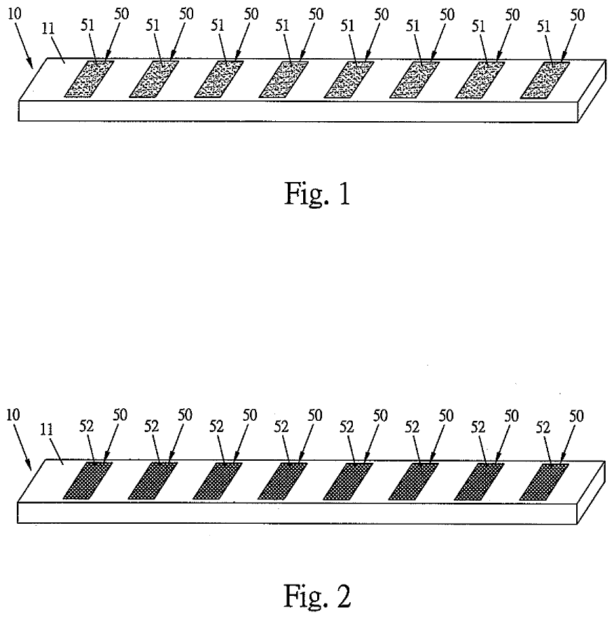

With reference to FIGS. 1 to 3, the structure of the present invention is illustrated. The present invention comprises following components.

A light strip 10, the light strip 10 is a strip formed by cyclic block copolymers (CBCs). The light strip 10 has an input end 20 to receive ultraviolet (UV) light 40. The ultraviolet light 40 is guided by the light strip 10 and passes through the light strip 10 from the input end 20 to an output end 30 of the light strip 10 by total internal reflection (TIR) within the light strip 10.

The cyclic block copolymers are made of fully hydrogenating block copolymers of styrene and conjugated diene by anionic polymerization. The cyclic block copolymers have remarkable thermal stability, excellent UV durability, extra-high transparency, low water absorption, low density and superb purity. The refractive index of the cyclic block copolymers is 1.47˜1.55 and the transmittance of the cyclic block copolymers is 90%˜94%. The cyclic block copolymers, such as “ViviOn™ 0510HF” and “ViviOn™ 0510HFE” produced by USI Corporation. ViviOn™ 0510HF and ViviOn™ 0510HFE can be processed with injection molding or extrusion molding. ViviOn™ 0510HF is a higher flow variant of “ViviOn™ 0510” of USI Corporation and is designed for easier processing. ViviOn™ 0510HFE is a EUT variant of ViviOn™ 0510HF and is specially designed for applications that require higher UV transmittance in the ultraviolet light C (UV-C, short-wave UV) range (200˜280 nm).

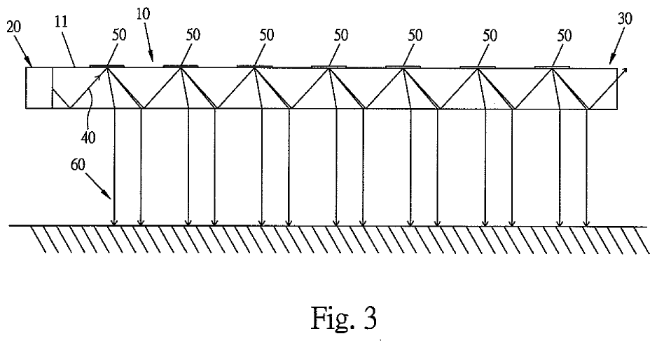

A side 11 of the light strip 10 forms at least one dielectric reflecting area 50. The dielectric reflecting area 50 has high dielectric permittivity to destroy the total internal reflection within the light strip 10. Referring to FIG. 3, the dielectric reflecting area 50 partially reflects the ultraviolet light 40 in the light strip 10 and change an angle between a direction of ultraviolet light 40 and a radial direction of the light strip 10 so that a part of the ultraviolet light 40 penetrates out of a side of the dielectric reflecting area 50 and leaves the light strip 10 to illuminate an external portion of the light strip 10.

Referring to FIG. 3, the at least one dielectric reflecting area 50 is a plurality of dielectric reflecting areas 50 formed at the side 11 of the light strip 10. The ultraviolet light 40 penetrates out of the dielectric reflecting areas 50 of the light strip 10 and forms a linear illuminating area 60. The linear illuminating area 60 in the FIG. 3 is only used as a schematic view sample for easily understanding. In fact, the linear illuminating area 60 has densely arranged ultraviolet light 40.

The dielectric reflecting area 50 is formed by ink 51 coated on the side 11 of the light strip 10 or is formed by at least one scratch 52 carved on the side 11 of the light strip 10. The ink 51 or scratch 52 serves to change dielectric permittivity of the dielectric reflecting area 50. Therefore, the dielectric reflecting area 50 is capable of changing an angle of reflection of the ultraviolet light 40 in the light strip 10 and destroys the total internal reflection within the light strip 10.

Referring to FIG. 3, in normal application, when the ultraviolet light 40 enters into the light strip 10, strength of the ultraviolet light 40 is decreased with the increase of traveling length of the ultraviolet light 40. Normally, when the side 11 of the light strip 10 is arranged with a plurality of dielectric reflecting areas 50, strength of the ultraviolet light 40 of the linear illuminating area 60 near the input end 20 is larger than strength of the ultraviolet light 40 of the linear illuminating area 60 far away from the input end 20. As a result, it is not ideal for achieving the requirement of actual applications. To obtain an uniform strength of the ultraviolet light 40 in every position of the linear illuminating area 60 and a minimum strength of the ultraviolet light 40 at the output end 30 of the light strip 10, the ink 51 or the scratch 52 of the dielectric reflecting area 50 is formed as a specific form or is spaced with a specific distance from the ink 51 or scratch 52 of adjacent dielectric reflecting area 50 so that the present invention has maximum illuminating efficiency.

The CBC light strip structure of the present invention is used as a light source of a contact image sensor (CIS) and the light source serves for scanning banknotes, identity cards, passports and so on for identification.

Advantages of the present invention are that the CBC light strip structure is made of cyclic block copolymers (CBCs) for guiding the ultraviolet light. Therefore, the light strip of the present invention can be used to scan documents which only can reflect ultraviolet light, such as banknotes, identity cards, passports and so on. The structure of the present invention can overcome the problem that the acrylic light strip cannot guide ultraviolet light. Comparing to traditional LED light strip, the light strip of the present invention has a simple structure and low costs. The light strip of the present invention does not have the problem that the LED light strip must be scrapped once the LED is damaged, thus the light strip of the present invention has longer service life.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A CBC light strip structure capable of guiding ultraviolet light comprising:
a light strip formed by cyclic block copolymers (CBCs); the light strip having an input end to receive ultraviolet (UV) light; the ultraviolet light being guided by the light strip and passing through the light strip from the input end to an output end of the light strip.

2. The CBC light strip structure capable of guiding ultraviolet light as claimed in claim 1, wherein the cyclic block copolymers are made of fully hydrogenating block copolymers of styrene and conjugated diene by anionic polymerization.

3. The CBC light strip structure capable of guiding ultraviolet light as claimed in claim 1, wherein a side of the light strip forms at least one dielectric reflecting area having high dielectric permittivity to partially reflect the ultraviolet light in the light strip and change an angle between a direction of ultraviolet light and a radial direction of the light strip so that a part of the ultraviolet light penetrates out of a side of the dielectric reflecting area and leaves the light strip to illuminate an external portion of the light strip.

4. The CBC light strip structure capable of guiding ultraviolet light as claimed in claim 3, wherein the at least one dielectric reflecting area is a plurality of dielectric reflecting areas; the ultraviolet light penetrating out of the dielectric reflecting areas forms a linear illuminating area.

5. The CBC light strip structure capable of guiding ultraviolet light as claimed in claim 3, wherein the dielectric reflecting area is formed by ink coated on the side of the light strip; the ink serves to change dielectric permittivity of the dielectric reflecting area; and therefore, the dielectric reflecting area is capable of changing an angle of reflection of the ultraviolet light in the light strip.

6. The CBC light strip structure capable of guiding ultraviolet light as claimed in claim 5, wherein the ink on the dielectric reflecting area is formed as a specific form or is spaced with a specific distance from the ink on another adjacent dielectric reflecting area.

7. The CBC light strip structure capable of guiding ultraviolet light as claimed in claim 3, wherein the dielectric reflecting area is formed by at least one scratch carved on the side of the light strip; the scratch serves to change dielectric permittivity of the dielectric reflecting area; and therefore, the dielectric reflecting area is used to change an angle of reflection of the ultraviolet light in the light strip.

8. The CBC light strip structure capable of guiding ultraviolet light as claimed in claim 7, wherein the scratch of the dielectric reflecting area is formed as a specific form or is spaced with a specific distance from the scratch of another adjacent dielectric reflecting area.

9. The CBC light strip structure capable of guiding ultraviolet light as claimed in claim 1, wherein the CBC light strip structure is used as a light source of a contact image sensor (CIS) for scanning banknotes, identity cards and passports for identification.

10. The CBC light strip structure capable of guiding ultraviolet light as claimed in claim 1, wherein refractive index of the cyclic block copolymers is 1.47˜4.55 and transmittance of the cyclic block copolymers is 90%˜94%.
